(19) United States
(12) Patent Application Publication
(10) Pub. No.: US 2026/0367023 A1
(43) Pub. Date: Nov. 19, 2026

(54) APPARATUS AND METHOD FOR ACCELERATING EIS MEASUREMENT

(71) Applicant: Autosilicon Inc., Seoul (KR)

(72) Inventors: Junho SHIN, Seoul (KR); Junseok LEE, Daejeon (KR); Donghyeon KIM, Daejeon (KR)

(73) Assignee: Autosilicon Inc., Seoul (KR)

(21) Appl. No.: 19/549,217

(22) Filed: Feb. 25, 2026

(30) Foreign Application Priority Data
May 16, 2025 (KR) 10-2025-0063619

(51) Int. Cl. G01N 27/02

(52) U.S. Cl. CPC G01N 27/026

(57) ABSTRACT

An EIS measurement acceleration apparatus according to an embodiment of the present disclosure may include a signal estimator configured to predict a response signal based on an input signal of a DUT received from a Device Under Test (DUT), a DFT-NCO configured to extract only a specific frequency component included in the response signal output from the signal estimator, an impedance calculator configured to calculate an impedance of the DUT based on an output value of the DFT-NCO, and a controller.

### CROSS-REFERENCE TO RELATED APPLICATIONS

This application claims priority under 35 U.S.C. § 119 to Korean Patent Application No. 10-2025-0063619, filed on May 16, 2025, in the Korean Intellectual Property Office (KIPO), the entire disclosure(s) of which is hereby incdorporated herein by reference in its entirety.

### TECHNICAL FIELD

The present disclosure relates to an apparatus and method for accelerating Electrochemical Impedance Spectroscopy (EIS) measurement, which shortens an EIS measurement time and reduces circuit complexity. More particularly, the present disclosure relates to an apparatus and method for accelerating EIS measurement, including: (i) a prediction-based signal estimator configured to estimate a full-cycle response by using only a portion of an input EIS signal; and (ii) a frequency converter structure configured to efficiently extract only desired frequency components.

### BACKGROUND

The descriptions below are intended to assist in understanding the technical significance of the disclosure and do not presuppose that the disclosure was known prior to filing. Therefore, the description in the Background section should not be construed as an admission that such information constitutes prior art.

EIS is used as a method for quantitatively analyzing operating characteristics of various electrochemical systems such as lithium-ion batteries, fuel cells, supercapacitors, sensors, and bio-electrodes in a frequency domain. EIS sequentially applies a small-amplitude sinusoidal voltage to a system over a plurality of frequencies, measures a resulting current response to obtain an impedance, and separates the impedance into a real part and an imaginary part for visualization as, for example, a Nyquist plot or a Bode plot. Accordingly, parameters such as interfacial resistance, charge double-layer capacitance, and Warburg impedance can be modeled, which is usefully utilized for diagnosing a state of a battery, evaluating physical properties of a material, and analyzing electrode/electrolyte interface characteristics. In particular, it is considered an essential diagnostic tool for State of Health (SOH) and State of Charge (SOC) estimation and Remaining Useful Life (RUL) prediction of batteries in electric vehicles (EV), energy storage systems (ESS), and medical diagnostic devices.

To implement such EIS, a signal covering a wide frequency range (several mHz to several MHz) must be applied, and response data corresponding to each frequency point must be measured with high precision; for this purpose, a measurement structure based on a digital lock-in amplifier (DLIA) has been generally used in the prior art. The DLIA operates to selectively respond to a specific frequency and is configured with a structure using a mixer and a low-pass filter to extract only a component matching a reference frequency among frequency components included in an applied signal. The DLIA multiplies a signal measured from an external device under test (DUT) by an internally generated reference sine/cosine wave signal, removes high-frequency components, and leaves only valid components near DC, thereby precisely extracting impedance of a frequency to be measured.

FIG. 1A illustrates a circuit configuration diagram of such a conventional DLIA 100, wherein a signal 110 received from a DUT branches into two mixers 121 and 122 to be multiplied by a reference cosine wave and a reference sine wave, respectively. In this case, the reference wave is generated from a numerically controlled oscillator (NCO) 125, wherein a cosine (COS) signal is transferred to the upper mixer 121 and a sine (SIN) signal is transferred to the lower mixer 122, respectively. Signals multiplied in the mixers 121 and 122 pass through digital low-pass filters (DLPF) 131 and 132, respectively, wherein the DLPF is implemented as a high-order finite impulse response (FIR) or infinite impulse response (IIR) filter to remove high-frequency components, particularly 2f components generated by mixing, and extract a DC component (Vp/2). In this structure, an output of the upper filter 131 corresponds to a quadrature-phase component having a 90° phase difference, and an output of the lower filter 132 corresponds to an in-phase component. Complex impedance may be calculated using the two components.

FIG. 1B illustrates a frequency domain-based operation process of the DLIA 100 shown in FIG. 1A step by step. In a DUT Output step S110, a frequency spectrum of a response signal generated by an input voltage is composed of DC (Vos) and a component (Vp) at a frequency f. In the mixer output step (S120), frequency components are separated into DC and 2f components, and the DC component is shifted into a 1f frequency region. Thereafter, in an LPF1 Output step S130, high frequencies are attenuated around DC according to frequency response characteristics of the FIR/IIR filter to reduce the 2f component, and the 1f component may also be removed. Finally, in an LPF2 Output step S140, only the DC component among low-frequency components generated through a synchronous detection process passes, and this DC component can be interpreted as a real component or an imaginary component constituting the impedance of the DUT. Such a filtering process is essential for accurately extracting each frequency component, but a settling time of the filter is necessarily required, and a problem becomes serious particularly during low-frequency measurement.

Specifically, since a cycle of a low-frequency component (for example, 0.1 Hz) important in EIS measurement reaches 10 seconds, it takes at least 10 seconds to measure one complete cycle, and a settling time of LPF1 and LPF2 is additionally required for about 30 seconds or more. This means that it takes 40 seconds or more to measure only one frequency point, and it may take several hours to construct the entire EIS spectrum requiring sequential measurement of dozens of frequencies. Such a delay conflicts with a demand for estimating a state of a battery in real time in an EV or performing real-time anomaly detection in an ESS system. In addition, since the digital filter requires a large circuit area and high power consumption for implementation, it is disadvantageous for high-integration small chip design and has limitations in implementing a parallel processing structure.

Consequently, FIG. 1A and FIG. 1B show that although the conventional DLIA structure may be suitable for a high-precision analysis environment, it has limitations in application to next-generation power control systems, portable biosensors, embedded measurement devices, and the like, which simultaneously require high-speed response and computational efficiency. Therefore, a new approach capable of precise impedance estimation without collecting full-cycle data is required.

### SUMMARY

An objective of the present disclosure is to shorten a measurement time in EIS measurement. In particular, an object is to solve a problem that measurement time takes excessively long in a low-frequency region.

Another object is to solve problems of increased filter settling time and circuit area burden caused by a high-order low-pass filter used in a traditional DLIA structure.

Still another object is to provide a computational structure capable of reducing an entire frequency computation burden occurring in a conventional Fast Fourier Transform (FFT) method and effectively extracting only an impedance component corresponding to a specific frequency.

However, technical tasks to be achieved by the present embodiment are not limited to the technical tasks described above, and other technical tasks may exist.

An EIS measurement acceleration apparatus for measuring impedance of a device under test (DUT) according to an embodiment of the present disclosure may include: a signal estimator configured to predict a response signal based on a measured response signal of the DUT received from the DUT; a DFT-NCO configured to extract only a specific frequency component included in the response signal output from the signal estimator; an impedance calculator configured to calculate the impedance of the DUT based on an output value of the DFT-NCO; and a controller.

According to an embodiment, the signal estimator may be configured to predict the response signal after collecting only a partial section of the measured response signal.

According to an embodiment, the signal estimator may include at least one of a filter or an artificial intelligence prediction algorithm.

According to an embodiment, the filter may be composed of any one of a Kalman Filter, an Extended Kalman Filter, an Unscented Kalman Filter, a Particle Filter, a Wiener Filter, a Moving Average Filter, or an Auto-regression based filter.

According to an embodiment, the artificial intelligence prediction algorithm may include at least one of a Recurrent Neural Network (RNN), a Generative Adversarial Network (GAN), a Long Short-Term Memory (LSTM) network, a Convolutional Neural Network (CNN), a Transformer, a Graph Neural Network (GNN), or a Large Language Model (LLM).

According to an embodiment, the signal estimator may terminate prediction when a deviation between a predicted waveform and a measured waveform converges to a preset threshold value or less.

According to an embodiment, the signal estimator may perform basis vector-based extrapolation on a remaining section of an entire cycle after deviation convergence.

According to an embodiment, the signal estimator may estimate a phase and a period of a waveform using a differential value and a zero-crossing point of the measured response signal, and then estimate a value.

According to an embodiment, the signal estimator may apply a plurality of prediction models in parallel and select a model selectively reflecting a result with high prediction accuracy.

According to an embodiment, the DFT-NCO may include a Numerically Controlled Oscillator (NCO) and extract only a desired frequency component by performing a complex inner product operation based on sine and cosine waveforms.

According to an embodiment, the DFT-NCO may extract the frequency component using a real-based complex multiplier without using a twiddle factor.

According to an embodiment, the DFT-NCO may be capable of dynamically changing a frequency component of interest according to a frequency setting signal received from the controller.

According to an embodiment, the impedance calculator may receive real part and imaginary part outputs of the DFT-NCO and calculate the impedance of the DUT.

According to an embodiment, the impedance calculator may calculate impedance based on a phase difference and magnitude of voltage and current by receiving a real part and an imaginary part of a frequency component as an input.

According to an embodiment, the controller may transmit a control signal including a measurement frequency setting, a sampling length, a prediction period, and a repetition condition to the signal estimator, the DFT-NCO, and the impedance calculator.

According to an embodiment, the apparatus may further include a memory electrically coupled to the signal estimator, the DFT-NCO, the impedance calculator, and the controller.

According to an embodiment, the signal estimator, the DFT-NCO, the impedance calculator, the controller, and the memory may be electrically coupled via a bus to operate independently.

According to an embodiment, the controller may adjust a measurement period or limit the number of repetitions according to a rate of change of a measurement result or a prediction error rate.

According to an embodiment, the controller may perform a frequency sweep operation of sequentially referring to a frequency list including a plurality of frequency set values and controlling the DFT-NCO to repeatedly extract a signal component for each designated frequency section.

A signal prediction method according to another embodiment of the present disclosure includes collecting an initial section of a DUT signal from a DUT, predicting a signal based on the collected initial section of the DUT signal, and outputting the predicted signal to a subsequent processing module, wherein the predicting may be performed using at least one of a filter, a basis vector-based mathematical model, or an artificial intelligence-based prediction algorithm.

According to an embodiment, the predicting may terminate prediction when a deviation between a predicted waveform and a measured waveform converges to a preset threshold value or less.

According to an embodiment, the predicting may perform basis vector-based extrapolation on a remaining section of an entire cycle after convergence of the deviation.

According to an embodiment, the predicting may estimate a phase and a period of a waveform using a differential value and a zero-crossing point of the input DUT signal, and then configure a subsequent section in a form of a basis vector.

According to an embodiment, the predicting may include a model selection step of applying a plurality of prediction models in parallel and selectively reflecting a result having high prediction accuracy.

A method for extracting a specific frequency component according to another embodiment of the present disclosure includes generating a sine wave and a cosine wave for an input signal using a Numerically Controlled Oscillator (NCO), performing a complex inner product operation between the generated sine wave and cosine wave and the input signal, and extracting only a response component corresponding to a designated frequency, wherein the DFT-NCO may perform frequency component extraction without using a twiddle factor.

According to an embodiment, the performing of the complex inner product operation may calculate a response value for a specific frequency component by performing multiplication of the input signal with each of the generated sine wave and cosine wave and accumulating a result thereof.

According to an embodiment, the extracting may be sequentially repeated for a plurality of frequency components, and each frequency may be selected according to a frequency setting list transmitted from a controller.

According to an embodiment, the sine wave and the cosine wave may be dynamically generated by accumulating a fixed phase increment in the numerically controlled oscillator.

According to an embodiment, the complex inner product operation may reduce computational complexity by using a real-based complex multiplier.

According to the present disclosure, an EIS measurement time can be dramatically shortened by predicting an entire response using only a partial section of an input signal.

In addition, according to the present disclosure, a desired frequency component can be precisely extracted without a high-order digital filter, thereby reducing a circuit area and power consumption.

Furthermore, according to the present disclosure, a total computation amount and complexity are reduced through a direct calculation structure for a specific frequency component, thereby enabling implementation of a high-speed and miniaturized impedance measurement system.

However, technical objects to be achieved by embodiments of the present disclosure are not limited to the technical objects described above, and other technical objects may exist.

### BRIEF DESCRIPTION OF THE DRAWINGS

FIG. 1A is a diagram illustrating a circuit configuration of a conventional DLIA.

FIG. 1B is a diagram illustrating a frequency domain-based operation process of the DLIA of FIG. 1A.

FIG. 2 is a block diagram schematically illustrating a hardware configuration of an EIS measurement acceleration apparatus according to an embodiment of the present disclosure.

FIG. 3 is a diagram illustrating a detailed hardware configuration of the EIS measurement acceleration apparatus according to an embodiment of the present disclosure.

FIG. 4A is a diagram illustrating an operation of a signal estimator of the present disclosure.

FIG. 4B is a graph illustrating a learning process of collecting measured data for an initial section and calculating a waveform of a next time point while continuously updating a difference between a predicted value and a measured value.

FIG. 4C is a graph illustrating a process of constructing a remaining section only through prediction by omitting an update process after learning is completed up to a certain time point.

FIG. 5A is a diagram illustrating a calculation flow inside a DFT-NCO.

FIG. 5B is a diagram illustrating that a specific frequency is selected by the DFT-NCO.

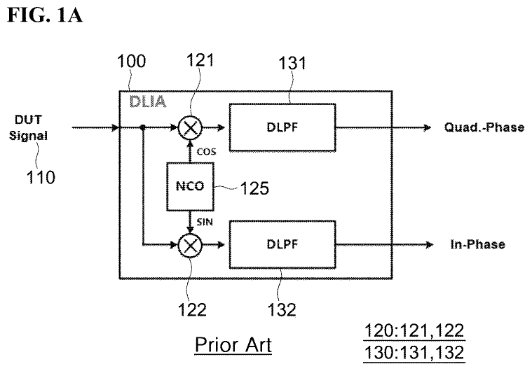

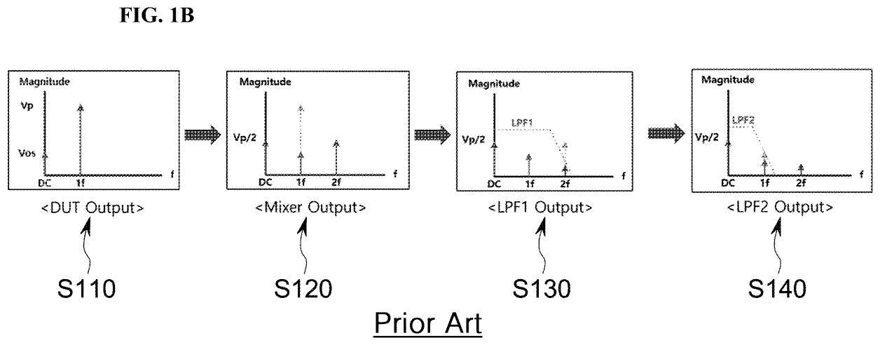

### DETAILED DESCRIPTION

Since the present disclosure may apply various changes and have various embodiments, specific embodiments will be illustrated in the drawings and described in detail in the detailed description. However, this is not intended to limit the present disclosure to specific embodiments, and it should be understood to include all modifications, equivalents, or substitutes included in the spirit and technical scope of the present disclosure.

In order to clearly describe the present disclosure, parts irrelevant to the description are omitted in the drawings, and similar reference numerals are assigned to similar parts throughout the specification. In addition, while describing with reference to the drawings, even components indicated by the same name may have different reference numerals depending on the drawings, and the reference numerals are merely described for convenience of description, and the concept, feature, function, or effect of each component is not limitedly interpreted by the corresponding reference numeral.

In describing each drawing, similar reference numerals are used for similar components. Terms such as first, second, and the like may be used to describe various components, but the components should not be limited by the terms. The terms are used only for the purpose of distinguishing one component from another component. For example, without departing from the scope of rights of the present disclosure, a first component may be referred to as a second component, and similarly, a second component may also be referred to as a first component. Unless defined otherwise, all terms used herein, including technical or scientific terms, have the same meaning as commonly understood by one of ordinary skill in the art to which the present disclosure belongs.

Terms such as those defined in generally used dictionaries should be interpreted as having a meaning consistent with the meaning in the context of the related art, and should not be interpreted in an idealized or excessively formal meaning unless clearly defined in the present application.

Throughout the specification, when a part is referred to as being “connected” to another part, this includes not only a case where it is “directly connected” but also a case where it is “electrically connected” with another element interposed therebetween. In addition, when a part is referred to as “including” a component, this means that it may further include other components rather than excluding other components unless specifically stated to the contrary, and it should be understood that the presence or addition possibility of one or more other features, numbers, steps, operations, components, parts, or combinations thereof is not precluded in advance.

In the present specification, ‘unit’ or ‘module’ means a software or hardware component. However, “unit” or “module” is not limited to hardware and software. “Unit” or “module” may be configured to reside in an addressable storage medium or may be configured to reproduce one or more processors. Therefore, as an example, “unit” or “module” includes components such as software components, object-oriented software components, class components, and task components, and processes, functions, attributes, procedures, subroutines, segments of program code, drivers, firmware, microcode, circuits, data, databases, data structures, tables, arrays, and variables. Functions provided within components and “units” or “modules” may be combined into a smaller number of components and “units” or “modules” or may be separated into additional components and “units” or “modules”.

Hereinafter, an apparatus and method for accelerating EIS measurement according to embodiments of the present disclosure will be described with reference to the drawings.

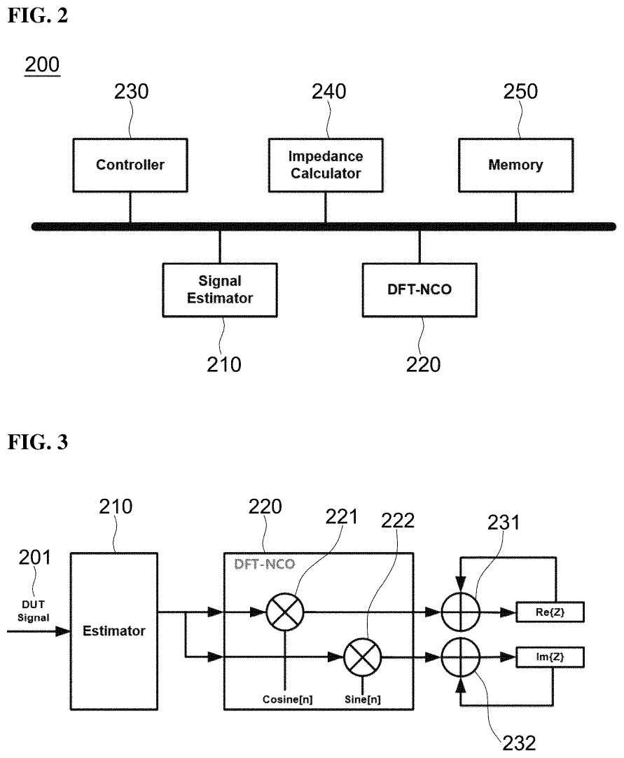

FIG. 2 is a diagram illustrating a hardware configuration of an EIS measurement acceleration apparatus, and FIG. 3 is a diagram illustrating a circuit configuration of an EIS measurement acceleration apparatus according to an embodiment of the present disclosure. FIG. 2 schematically illustrates a structure of each functional block included inside the measurement apparatus and a data flow therebetween. The entire system is configured such that a plurality of independent functional blocks are interlocked around a common data bus, and each component may be provided according to technical requirements for realizing high-speed data processing, precise measurement, and low-area integration.

Referring to FIGS. 2 and 3, the EIS measurement acceleration apparatus 200 may include a signal estimator 210, a DFT-NCO 220, a controller 230, an impedance calculator 240, and a memory 250. The signal estimator 210 performs a function of shortening a measurement time by predicting a full-cycle response based on a part of a signal collected from a DUT. The DFT-NCO 220 extracts a specific frequency component from a predicted signal and is configured to significantly reduce complexity compared to FFT based on a high-speed operation structure. The controller 230 is responsible for sequential control and timing synchronization of an entire measurement process, and manages an operation control flow of the entire system such as measurement condition setting, operation trigger generation, and memory control. The impedance calculator 240 calculates complex impedance based on the frequency component extracted by the DFT-NCO 220 and outputs a quantitative analysis result for each frequency. The memory 250 stores signal data, a prediction result, an operation intermediate value, and final impedance data, and includes a function of interfacing with the outside of the system or transmitting data to a subsequent processing system. Such a configuration is designed to facilitate parallel processing and scalability, and may be suitably applied to an EIS application environment requiring real-time diagnosis and high-speed measurement.

In more detail, the signal estimator 210 may perform a function of collecting only a partial section of an impedance response signal received from the DUT and predicting a full-cycle response based on data of the corresponding section. Unlike a conventional EIS measurement method requiring actual measurement of full-cycle data, the signal estimator 210 shortens a measurement time by estimating a subsequent signal with high precision using only a partial signal of an initial section, and may remove or significantly reduce a time delay occurring particularly in a low-frequency band. Such a signal prediction function may be realized by any one or a combination of a plurality of configuration modules, and may be implemented by, for example, any one operation device among a differentiator, an integrator, an AI algorithm, a probabilistic filter (Kalman filter, particle filter), an adjustment device, and a criteria checker device.

In some embodiments, the signal estimator 210 may analyze a time rate of change of an input signal through a differentiator or restore a cumulative waveform through an integrator, and may be configured such that a high-order prediction model such as an artificial intelligence algorithm or a filter operates based on such basic signal characteristics. In addition, an adjustment device may be included to correct a phase and an amplitude of a predicted waveform in real time, and a criteria checker device may be used to determine whether a prediction error has converged within a preset tolerance to control a prediction termination condition.

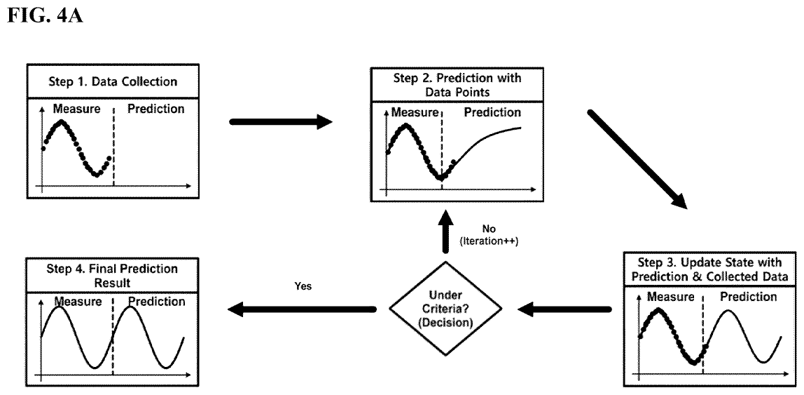

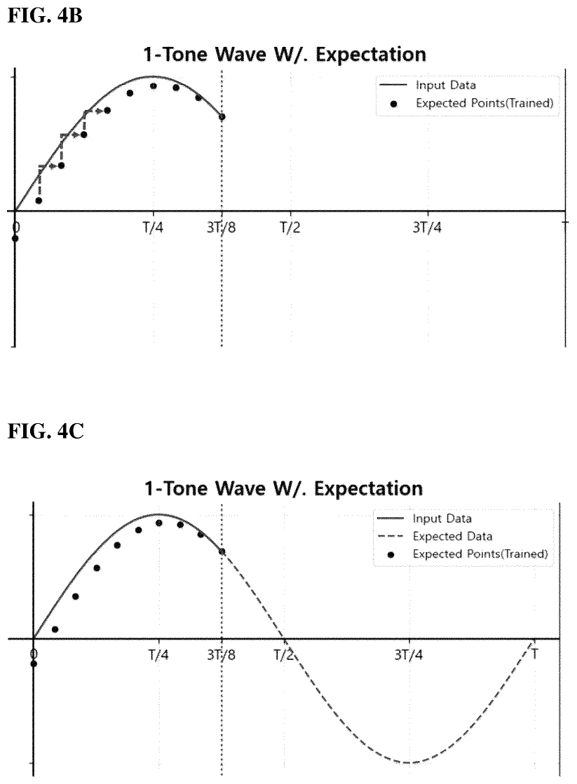

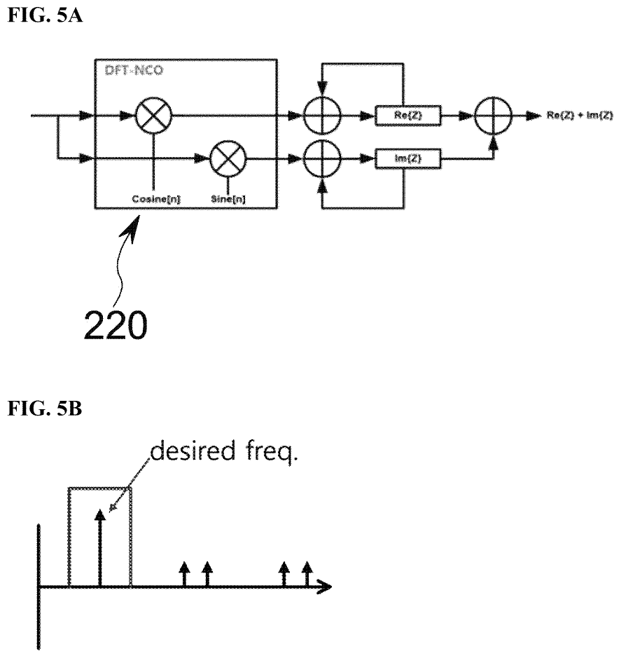

Among these various implementation methods, the signal estimator 210 may be configured preferably by applying a Kalman Filter, but is not limited thereto, and various filtering and prediction techniques may be used, such as a probabilistic state estimation filter such as an Extended Kalman Filter or a Particle Filter, as well as a Wiener Filter providing an optimal estimation based on a Minimum Mean Square Error (MSE), a Moving Average Filter alleviating a rapid fluctuation of a signal, and an Auto-regression (AR) model predicting a current value through a linear combination of past observation values. A Kalman filter-based configuration has a structure capable of correcting and predicting a signal in real time even in an environment where noise exists using a state-observation model, and a detailed configuration and operation method thereof will be described in detail through FIGS. 4 to 5 to be described later.

The DFT-NCO 220 may selectively extract only a specific frequency component with respect to a complex waveform included in a measured signal or a predicted signal input from the signal estimator 210, and may be implemented based on an operation architecture distinct from a conventional Fast Fourier Transform (FFT) method using a batch operation structure for a plurality of frequencies.

The DFT-NCO 220 includes a Numerically Controlled Oscillator (NCO) that defines a frequency component subject to operation in advance and internally generates a reference wave corresponding to the corresponding frequency, and includes a Complex Multiplier for performing a complex inner product operation between the reference wave and the input signal. Here, the NCO generates cosine and sine signals corresponding to a frequency in a digital manner, and the complex multiplier calculates a product of these reference signals and an input complex signal in real time to extract a real part and an imaginary part of a specific frequency component. In this case, since a Twiddle Factor-based operation routine is not required and a structure minimizing memory access is followed, there is a synergistic effect of significantly reducing a circuit area and power consumption compared to an existing FFT-based structure.

The DFT-NCO 220 is synchronously controlled in real time for operation timing, frequency resolution, the number of operation repetitions, and the like according to frequency setting information and a sample number control command received from the controller 230, and may extract a necessary part according to a measurement target frequency. The conventional FFT method has a limitation that unnecessary computational load occurs by collectively calculating a fixed transform size and an entire frequency spectrum, and selective analysis of a specific band or dynamic resolution adjustment is difficult because an entire operation block has a fixed structure.

On the other hand, since the DFT-NCO 220 performs an operation only on a target frequency component, an operation amount is reduced to an O(N) level, an operation bottleneck is resolved by limiting an operation target, and there is a technical advantage that integration possibility increases even in a System-on-Chip (SoC) or ASIC environment through a miniaturized operation core. In addition, since the DFT-NCO 220 follows a structure of generating a real-time reference wave without repeatedly accessing predetermined transform data on a memory, it is possible to dynamically respond without resetting a hardware structure even if an analysis target of a frequency component is changed.

The DFT-NCO 220 enables high-speed operation for a low-frequency component particularly when combined with a prediction-based measurement structure, and may extract only impedance of a desired band without measurement of all frequency components. Due to this, an entire measurement time is dramatically shortened compared to a method of performing sequential measurement for each frequency in an existing DLIA structure, and application to various operation scenarios such as intensive analysis for a specific band or high-resolution frequency scan is possible as needed. The DFT-NCO 220 has an advantage over the prior art in terms of real-time property, operation efficiency, and circuit integration density, and may be applied as a high-speed impedance analysis module in a multi-analysis environment requiring parallel operation of a plurality of EIS channels, a portable device, a real-time control device, and the like.

In particular, when configured in a manner of arranging a plurality of DFT-NCOs or impedance calculators to be described later in parallel, system throughput may be maximized since simultaneous extraction of a plurality of frequency components or simultaneous measurement for multiple DUTs is possible. A bus-based connection structure may simplify replacement or function expansion of components in a system by standardizing a physical interface between respective modules, and for example, upgrade is possible without changing an entire system structure even if replaced with a higher-performance signal estimator or a high-speed DFT-NCO.

The controller 230 may include a function of controlling an entire operation flow of the EIS measurement acceleration apparatus 200 and coordinating a synchronous operation procedure between respective operation blocks, and may consistently manage operation timing and a data transmission path between internal components of the system.

The controller 230 generates a measurement start signal in a start stage of EIS measurement, controls a time point and a period of signal collection from the DUT, and may set a prediction section and an end time point so that a part of the collected signal is transmitted to the signal estimator 210 to perform a prediction operation. Thereafter, the controller 230 designates a frequency setting value of the DFT-NCO 220, generates an operation control signal so that an inner product operation of a specific frequency component is performed at an accurate timing, and may adjust a flow of transmitting an output result of the DFT-NCO 220 to the impedance calculator 240.

The controller 230 generates an operation trigger signal of the impedance calculator 240 to determine an operation start time point, and performs a storage command for storing a result value in the memory 250 after completion of calculation, thereby causing an entire measurement and operation process to be configured according to a predetermined order and timing. Such a control signal may operate according to a preset sequence-based measurement scenario or a user-defined condition input through an external interface, and in this process, the controller 230 may include a state-based control routine for preventing operation overflow, data loss, and processing delay.

In some embodiments, the controller 230 may be implemented as a Microcontroller Unit (MCU)-based general-purpose control processor, or may be implemented as a dedicated control circuit having a Finite State Machine (FSM) structure in an application environment requiring high-speed sequential control, and operation processing speed, system responsiveness, and a circuit area optimization level may be adjusted according to an implementation method. When configured based on FSM, a control flag corresponding to each state is set, and automatic switching of a measurement condition and a restoration procedure for an abnormal situation may be included through a conditional transition condition. The controller 230 may also provide a flexible measurement environment corresponding to various measurement scenarios by including a function capable of dynamically adjusting a measurement frequency range, measurement resolution, the number of repetitions, and the like according to a system state.

As such, the controller 230 minimizes system response delay and prevents operation bottlenecks by optimizing an operation sequence of individual operation modules while consistently maintaining temporal control of the entire measurement system, and consequently, may be used to ensure real-time operation performance of the EIS measurement acceleration apparatus 200. In addition, the controller 230 enables real-time adjustment of measurement conditions, trigger conditions, result processing methods, and the like to suit an external environment through communication with a user interface or an external control system, thereby securing versatility and applicability in various measurement environments.

The impedance calculator 240 includes a function of calculating impedance based on complex frequency components for a current signal received from the DUT and an applied voltage signal, and is composed of an operation block that receives an input signal predicted through the signal estimator 210 and a specific frequency component extracted through the DFT-NCO 220 as inputs and calculates a complex impedance value. The impedance calculator 240 receives a complex component ΔV corresponding to a voltage signal and a complex component ΔI corresponding to a current signal by separating them into real part and imaginary part vectors, respectively, and processes them in a form of Z=ΔV/ΔI through a complex division operation, thereby numerically representing frequency response characteristics of the DUT.

The impedance calculator 240 periodically receives a complex voltage component and a complex current component provided as an output result of the DFT-NCO 220, sequentially calculates an impedance value corresponding to each frequency, and may perform repetitive operation in real time. An operation structure may be implemented as an Arithmetic Logic Unit (ALU)-based structure including a fixed-point or floating-point operation unit, and operation speed and area efficiency may be simultaneously secured through optimization of a complex number operation algorithm. The calculated impedance value may be visualized as a Nyquist plot or a Bode plot as a function of frequency, and may also be used as an input value of an equivalent circuit model estimation and state diagnosis algorithm of an electrochemical system.

The impedance calculator 240 may further include an interface capable of storing an operation result in the memory 250 under control of the controller 230 or directly transmitting the operation result to an external analysis device, and may also include functions such as adjustment of an operation period according to a change in measurement frequency, interruption of calculation upon occurrence of an exception condition, and return of an error code.

The memory 250 stores intermediate data of each operation process performed inside the EIS measurement acceleration apparatus 200, and maintains a history of a final impedance result value and a predicted signal, thereby securing data consistency and operation continuity of the entire system. The memory 250 preserves predicted signal data generated by the signal estimator 210 for a certain period of time to enable cumulative comparison during repeated measurement at the same frequency, and complex data of a frequency component extracted by the DFT-NCO 220 may also be temporarily stored and used as an auxiliary storage device in a stage prior to transmission to the impedance calculator 240.

In addition, the complex impedance value calculated by the impedance calculator 240 may be stored in the memory 250 together with a measurement time, a frequency setting value, and signal state information, which may be utilized later for electrochemical modeling, Nyquist plot construction, system state analysis, and the like.

In some embodiments, the memory 250 has read and write timings adjusted according to a control signal of the controller 230, and may be implemented based on a First-In-First-Out (FIFO) structure or a Dual-Port memory structure to minimize data transfer delay between respective operation modules. The FIFO structure enables processing of data in a first-in first-out manner without loss in an environment where a sequential operation flow is forced, and the Dual-Port structure has an advantage that parallel access is possible without data collision even if two or more operation modules access simultaneously.

The memory 250 may be implemented by selecting one of SRAM, DRAM, or non-volatile flash memory according to an operating environment and storage capacity requirements of the system, wherein a register and SRAM are preferable in a high-speed operation environment, and non-volatile memory may be adopted when large-capacity long-term storage is required.

The memory 250 may also be utilized as an interface buffer for data linkage with an external system, and may include functions such as format conversion, temporary caching, transmission packet segmentation, and the like for transmitting EIS measurement results to an external display, analysis software, or a server-based diagnostic system.

As described above, the EIS measurement acceleration apparatus 200 illustrated in FIG. 2 is configured in a manner in which a plurality of operation and control modules including the signal estimator 210, the DFT-NCO 220, the controller 230, the impedance calculator 240, and the memory 250 are interlocked through a common bus-based structure, and each of these modules is implemented in a form of a hardware-separated block while being designed to operate in an integrated manner according to an entire measurement flow. The bus-based structure provides a structural advantage capable of simultaneously securing system scalability, ease of module replacement, and possibility of computational parallelism by unifying an interface through which each component may exchange data while operating individually.

Next, an internal configuration and an operation principle of the signal estimator 210 and the DFT-NCO 220 illustrated in FIG. 3 will be described in more detail with reference to FIGS. 4A, 4B, and 4C.

FIG. 4A is a diagram illustrating a cyclic structure of an iterative prediction algorithm visually describing a prediction and update operation flow of the signal estimator 210, and is a graph-based procedural diagram expressing step-by-step a process of precisely restoring a remaining section through a sequential prediction-update process after measuring only a part of an entire signal period.

As illustrated in FIG. 4A, the signal estimator 210 may first collect a predetermined number of data in Step 1. In this Data Collection step, measured signal points are acquired up to a predetermined time range based on experimental data, and the collected points are indicated by black dots (*.*) in the drawing. Thereafter, in Step 2, a value of a future time point is predicted based on the collected data points, and the predicted value is indicated by a dotted line to represent an extension estimation of a measured waveform. The predicted value is a pre-calculation result for a point to be measured later, and is calculated through a filter or an AI-based prediction technique.

In Step 3, a state is updated based on a correlation between the previously predicted value and already collected data. This update process may be implemented through a prediction-update equation of a Kalman filter algorithm, and proceeds in a manner in which a system state estimate is integrated with a new observation value to reduce a prediction error. Specifically, prediction accuracy is iteratively improved through a process in which a prediction error covariance is updated and an estimate is refined. Step 2 and Step 3 are repeatedly performed until a convergence condition is satisfied. In this case, the convergence condition may be set to a Mean Squared Error (MSE), a Standard Deviation, or other predefined deviation threshold between the predicted value and the measured value.

A condition check statement checks whether the updated state is less than or equal to a reference error, and if not satisfied, repeats processes of Prediction, Update, and condition evaluation. At a time point when the repetition ends, that is, when the predicted signal reaches a level statistically matching the collected data, the process switches to Step 4, and in this step, Pure Prediction is performed for the remaining sections of the entire signal period. This final predicted signal is indicated by a solid line, and is utilized as a high-precision interpolation result corresponding to an extension of the measured signal.

The signal estimator 210 performing such a prediction flow is a module designed to solve a time delay problem occurring in a conventional full-section signal collection method, and enables a dramatic reduction in an entire measurement time by collecting only a partial section of an entire cycle and replacing the remainder through mathematical estimation. In particular, by controlling the number of repetitions through a deviation criterion of a certain level or more, an optimal balance between prediction accuracy and measurement speed may be automatically derived.

In addition, the signal estimator 210 may be configured in hardware as a filter block, an AI-based prediction operator, a state update operator, or a convergence criterion determiner, and these may operate in combination with a signal flow control circuit internally including a data collection pointer, a sampling clock controller, a history memory, and the like. Such a configuration ensures high-speed response and real-time processing of the entire system by executing repeated prediction in a form of a closed loop within a single operation block, and simultaneously enables a hardware design advantageous for miniaturization and power efficiency of the measurement apparatus.

FIG. 4B is a diagram visually expressing a process in which the signal estimator 210 learns collected measurement data in real time through a Kalman filter-based prediction-update structure and precisely predicts a signal at a subsequent time point based on the learned data. A solid line in the drawing indicates actual Input Data, black dots indicate Collected Data collected by the system, and a stepped dotted line indicates a prediction state in which a predicted value is repeatedly compared with a measured value and updated, thereby intuitively showing a convergence tendency of a predicted signal over time. Such an iterative prediction structure corresponds to an operation flow centrally performed by a Kalman filter operation module embedded in the signal estimator 210, and is configured through a prediction step and an update step.

First, in the prediction step, a next state \hat{x}_{k|k-1} and a covariance thereof P_{k|k-1} are modeled based on a state estimate value \hat{x}_{k-1|k-1} and an error covariance P_{k-1|k-1} at a previous time point. [Equation 1] and [Equation 2] used in this case are as follows.

$${\hat{x}}_{k \vert k − 1} = {A}_{k} {\hat{x}}_{k − 1 \vert k − 1} + {B}_{k} {u}_{k} \qquad [ Equation 1 ]$$

$${P}_{k \vert k − 1} = {A}_{k} {P}_{k − 1 = \vert k − 1} {A}_{k}^{T} + {Q}_{k} \qquad [ Equation 2 ]$$

Here, Aₖ is a state transition matrix, Bₖ is a control input matrix, uₖ is a control input vector, and Qₖ is a covariance matrix of process noise. The predicted state \hat{x}_{k|k-1} is an estimated value before being directly compared with a measured value, and corresponds to a start point of the dotted line of FIG. 4B.

In the update step, the predicted value is corrected using the measured value yₖ, and a calculated Kalman Gain follows [Equation 3] below.

$${K}_{k} = {P}_{k \vert k − 1} {H}_{k}^{T} {( {H}_{k} {P}_{k \vert k − 1} {H}_{k}^{T} + {R}_{k} )}^{− 1} \qquad [ Equation 3 ]$$

This Kalman gain determines a weight by reflecting relative reliability between the measured value and the predicted value, and a subsequent state is updated as in [Equation 4] and [Equation 5] below.

\hat{x}_{k|k}=\hat{x}_{k|k-1}+Kₖ(zₖ−Hₖ\hat{x}_{k|k-1}) [Equation 4]

P_{k|k}=(1−KₖHₖ)P_{k|k-1} [Equation 5]

Here, zₖ is a measured value, Hₖ is an observation matrix, Rₖ is a measurement noise covariance, and l is an identity matrix. The updated state estimate value \hat{x}_{k|k} is a result adjusted according to a deviation between the measured value and the predicted value, and is used again as an input of a next prediction to perform an iterative action.

The graph illustrated in FIG. 4B visually interprets such a mathematical process, and has a structure in which an initial predicted value has a certain error from a measured value but converges in a stepped shape through repetitive updates. The signal estimator 210 may reproduce an entire period signal with high precision using only some data collected in a specific section in a time domain through such repetitive operation, and may reduce an entire measurement time and streamline computational resources. Unlike the conventional sinusoidal wave measurement method relying on full-period measurement, this method may be very usefully applied in a high-speed EIS system by introducing a model-based correction technique to implement an optimal balance between measurement speed and accuracy.

FIG. 4C is a graph illustrating a step of restoring an entire signal only by internal state prediction without collecting measurement data any more after the signal estimator 210 completes learning based on an input signal of a predetermined section.

In the graph of FIG. 4C, a solid line indicates Input Data, black dots indicate collected Expected Points (Trained), and a dotted line indicates a predicted remaining period waveform (Expected Data).

In this case, only data before [3T/8], which is a reference time point, is a learning area secured through actual measurement, and a subsequent [3T/8, T] section means data configured based only on internal prediction. In the structure shown in FIG. 4C, since the measured value is no longer used, the update step is not performed.

Such a method provides a structure capable of dramatically reducing an entire measurement time and computational complexity compared to a method in which conventional EIS signal analysis apparatuses collect measurement data for an entire period and then process the measurement data. In particular, FIG. 4C shows an implementation structure clearly distinguished from the prior art in terms of real-time processing efficiency and computational resource reduction by generating a remaining section based on complete prediction after completing learning based on only some initial signals. The signal estimator 210 determines an end point of such repetitive measurement by itself according to a covariance convergence condition or an error threshold of the Kalman filter, and thereafter generates a signal only with an internal model, thereby enabling simultaneous achievement of minimization of a data collection section and precise frequency response analysis.

Meanwhile, although the embodiments illustrated in FIGS. 4A to 4C illustrate a periodic function as an example, the scope of application of the present disclosure is not limited to the periodic function and may be extended to various signal forms. For example, prediction-based signal restoration is possible even for a non-linear or non-periodic signal, and particularly, even in the case of an input signal having a repetitive form only for a partial section, the signal estimator 210 may perform prediction for a remaining section by analyzing and learning a correlation between data.

FIG. 5A and FIG. 5B are diagrams for describing a structure and an operation principle of the DFT-NCO 220 of the present disclosure, and the DFT-NCO 220 may reduce a calculation load and increase operation efficiency of an entire system by selectively extracting only a specific frequency component from a measured DUT signal.

Referring to FIG. 5A, the DFT-NCO 220 multiplies an input time series signal by signals of sine (Sine[n]) and cosine (Cosine[n]) types generated by an NCO in a multiplier, and then accumulates respective output values to calculate a real part (Re{Z}) and an imaginary part (Im{Z}), thereby extracting it in the form of a complex frequency component Z=Re(Z)+j·Im(Z). Since an inner product operation used herein is performed for a fixed frequency, unlike entire FFT, only a specific frequency component may be selectively extracted without a need to collectively calculate for all frequencies.

Conventional frequency analysis has a computational complexity O(N²) of for a total of N samples, and processes all frequency components collectively. On the other hand, since the DFT-NCO 220 according to the present disclosure calculates only one DFT point for a frequency of interest fₖ, complexity is significantly lowered to O(N).

$${W}_{N}^{k} = {e}^{- j \cdot 2 π k / N} \qquad [ Equation 6 ]$$

In the present disclosure, cos (2πkn/N) and sin (2πka/N) values are directly generated in real time within an NCO block without a need to pre-calculate or store a Twiddle Factor of [Equation 6], and an inner product is performed by a real-based multiplier, so that memory usage and operation complexity are dramatically reduced. As such, a method of removing a Twiddle Factor and directly generating and multiplying Cosine[n] and Sine[n] simplifies a structure of a complex multiplier, and in particular, there is an advantage of reducing a scale of a hardware circuit through a real number complex multiplier structure using only a real coefficient.

In addition, as illustrated in FIG. 5B, although a plurality of frequency components may exist in an entire frequency domain, the DFT-NCO 220 may selectively extract only a desired frequency component (desired freq.) among them. According to a control signal of the controller 230, a desired frequency fₖ may be adjusted in a unit of a frequency interval as shown in [Equation 7] below based on a sampling frequency Fₛ and the total number of samples N.

$${f}_{interval} = \frac{{F}_{s}}{N} \qquad [ Equation 7 ]$$

Accordingly, a user may command to extract a DFT component for a specific frequency fₖ=k·fᵢₙₜₑᵣᵥₐₗ through the controller 230, thereby enabling selective analysis for an arbitrary point on a DUT response spectrum requiring measurement. Such frequency selectivity provides a structure capable of quickly analyzing only a desired frequency by escaping from limitations of a fixed interval and a fixed operation amount of a traditional FFT method, and enables efficient system implementation in an application field such as electrochemical impedance spectrum analysis requiring high-resolution frequency analysis.

The DFT-NCO 220 is configured to depart from a classical DFT structure having a computational complexity of O(N²) and to perform a single-frequency analysis with a complexity of O(N) only for a selected frequency, thereby achieving improved performance of the entire EIS measurement acceleration apparatus in terms of computational efficiency, power consumption, response speed, and the like. This is applicable to an environment having limited hardware resources or a low-power mobile-based analysis device, and may be utilized as a suitable frequency analysis architecture in an application environment requiring real-time analysis.

The apparatus described above may be implemented as a hardware component, a software component, and/or a combination of a hardware component and a software component. For example, the apparatus and components described in the embodiments may be implemented using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may execute an Operating System (OS) and one or more software applications running on the Operating System. In addition, the processing device may access, store, manipulate, process, and generate data in response to execution of software. For convenience of understanding, although one processing device is sometimes described as being used, one of ordinary skill in the art will recognize that the processing device may include a plurality of processing elements and/or a plurality of types of processing elements. For example, the processing device may include a plurality of processors or one processor and one controller. Also, other processing configurations are possible, such as a parallel processor.

The software may include a computer program, code, instructions, or a combination of one or more thereof, and may configure the processing device to operate as desired, or may independently or collectively command the processing device. The software and/or data may be embodied in any type of machine, component, physical device, computer storage medium, or device to be interpreted by the processing device or to provide instructions or data to the processing device. The software may be distributed over networked computer systems so that it may be stored or executed in a distributed manner. The software and data may be stored in one or more computer-readable recording media.

The method according to the embodiment may be implemented in the form of program instructions that can be executed through various computer means and recorded in a computer-readable medium. In this case, the medium may continuously store a computer-executable program or may temporarily store the program for execution or download. In addition, the medium may be various recording means or storage means in a form in which a single or several pieces of hardware are combined, and is not limited to a medium directly connected to a certain computer system, but may be distributed on a network. Examples of the medium may include magnetic media such as hard disks, floppy disks, and magnetic tapes, optical recording media such as CD-ROMs and DVDs, magneto-optical media such as floptical disks, and media configured to store program instructions, including ROM, RAM, flash memory, and the like. In addition, examples of other media may include recording media or storage media managed by app stores that distribute applications, sites that supply or distribute various other software, servers, and the like.

As described above, although the embodiments have been described with limited embodiments and drawings, various modifications and variations may be made from the above description by those skilled in the art. For example, appropriate results may be achieved even if the described techniques are performed in an order different from that described, and/or components of the described systems, structures, devices, or circuits are combined or arranged in forms different from those described, or are replaced or substituted with other components or equivalents.

Therefore, other implementations, other embodiments, and equivalents to the claims also fall within the scope of the claims described below.

### REFERENCE NUMERALS

100: DLIA
110, 201: DUT Signal
120, 121, 122, 221, 222: Mixer
125: NCO
130, 131, 132: DLPF
200: EIS Measurement Acceleration Apparatus
210: Signal Estimator
220: DFT-NCO
230: Controller
231, 232: Adder
240: Impedance Calculator
250: Memory

What is claimed is:

1. An apparatus for accelerating Electrochemical Impedance Spectroscopy (EIS) measurement for measuring an impedance of a Device Under Test (DUT), the apparatus comprising:
a signal estimator configured to predict a measured response signal based on an input signal of the DUT received from the DUT;
a DFT-NCO configured to extract only a specific frequency component included in the response signal output from the signal estimator;
an impedance calculator configured to calculate an impedance of the DUT based on an output value of the DFT-NCO; and
a controller configured to control operations of the signal estimator, the DFT-NCO, and the impedance calculator.

2. The apparatus of claim 1, wherein the signal estimator is configured to collect only a partial section of the measured response signal and then predict the response signal.

3. The apparatus of claim 2, wherein the signal estimator includes at least one of a filter or an artificial intelligence prediction algorithm.

4. The apparatus of claim 3, wherein the filter comprises any one of a Kalman Filter, an Extended Kalman Filter, an Unscented Kalman Filter, a Particle Filter, a Wiener Filter, a Moving Average Filter, or an Auto-regression based filter.

5. The apparatus of claim 3, wherein the artificial intelligence prediction algorithm includes at least one of a Recurrent Neural Network (RNN), a Generative Adversarial Network (GAN), a Long Short-Term Memory (LSTM) network, a Convolutional Neural Network (CNN), an attention-based Transformer series, a Graph Neural Network (GNN) utilizing temporal and spatial information, or a Large Language Model (LLM).

6. The apparatus of claim 1, wherein the signal estimator is configured to terminate prediction and learning when a deviation between a predicted waveform and a measured waveform converges to a preset threshold value or less.

7. The apparatus of claim 6, wherein the signal estimator is configured to perform basis vector-based extrapolation on a remaining section of an entire cycle after convergence of the deviation.

8. The apparatus of claim 1, wherein the signal estimator is configured to estimate a phase and a period of a waveform using a differential value and a zero-crossing point of the measured response signal, and then configure a subsequent section in a form of a basis vector.

9. The apparatus of claim 1, wherein the signal estimator is configured to apply a plurality of prediction models in parallel and select a model selectively reflecting a result with high prediction accuracy.

10. The apparatus of claim 1, wherein the DFT-NCO includes a Numerically Controlled Oscillator (NCO) and is configured to extract only a desired frequency component by performing a complex inner product operation based on sine and cosine waveforms.

11. The apparatus of claim 10, wherein the DFT-NCO is configured to extract the frequency component using a real-based complex multiplier without using a twiddle factor.

12. The apparatus of claim 10, wherein the DFT-NCO is configured to be capable of dynamically changing a frequency component of interest according to a frequency setting signal received from the controller.

13. The apparatus of claim 1, wherein the impedance calculator is configured to receive real part and imaginary part outputs of the DFT-NCO and calculate the impedance of the DUT.

14. The apparatus of claim 13, wherein the impedance calculator is configured to receive a real part and an imaginary part of the frequency component as an input and calculate impedance based on a phase difference and magnitude of voltage and current.

15. The apparatus of claim 1, wherein the controller is configured to transmit a control signal including a measurement frequency setting, a sampling length, a prediction period, and a repetition condition to the signal estimator, the DFT-NCO, and the impedance calculator.

16. The apparatus of claim 1, further comprising a memory electrically coupled to the signal estimator, the DFT-NCO, the impedance calculator, and the controller.

17. The apparatus of claim 16, wherein the signal estimator, the DFT-NCO, the impedance calculator, the controller, and the memory are electrically coupled to each other through a bus and configured to operate independently.

18. The apparatus of claim 1, wherein the controller is configured to adjust a measurement period or limit the number of repetitions according to a rate of change of a measurement result or a prediction error rate.

19. The apparatus of claim 1, wherein the controller is configured to perform a frequency sweep operation of sequentially referring to a frequency list including a plurality of frequency set values and controlling the DFT-NCO to repeatedly extract a signal component for each designated frequency section.

20. A signal prediction method performed by a signal estimator of an EIS measurement acceleration apparatus, the method comprising:
collecting an initial section of a DUT signal from a Device Under Test (DUT);
predicting a signal based on the collected initial section of the DUT signal; and
outputting the predicted signal to a subsequent processing module,
wherein the predicting is performed using at least one of a probabilistic prediction filter, an auto-regressive filter, a basis vector-based mathematical model, or an artificial intelligence-based prediction algorithm.

21. The method of claim 20, wherein
the predicting further comprises terminating the prediction when a deviation between a predicted waveform and a measured waveform converges to a preset threshold value or less.

22. The method of claim 21, wherein
the predicting comprises performing basis vector-based extrapolation on a remaining section of an entire cycle after convergence of the deviation.

23. The method of claim 20, wherein
the predicting comprises estimating a phase and a period of a waveform using a differential value and a zero-crossing point of the input DUT signal, and then configuring a subsequent section in a form of a basis vector.

24. The method of claim 20, wherein
the predicting further comprises a model selection step of applying a plurality of prediction models in parallel and selectively reflecting a result with high prediction accuracy.

25. A method for extracting a specific frequency component performed by a DFT-NCO of an EIS measurement acceleration apparatus, the method comprising:
generating a sine wave and a cosine wave for an input signal using a Numerically Controlled Oscillator (NCO);
performing a complex inner product operation between the generated sine and cosine waves and the input signal; and
extracting only a response component corresponding to a designated frequency,
wherein the DFT-NCO performs frequency component extraction without using a twiddle factor.

26. The method of claim 25, wherein
the performing of the complex inner product operation comprises performing multiplication of the input signal with each of the generated sine wave and cosine wave, and accumulating a result thereof to calculate a response value for the specific frequency component.

27. The method of claim 25, wherein
the extracting is sequentially repeated for a plurality of frequency components, and each frequency is selected according to a frequency setting list transmitted from a controller.

28. The method of claim 25, wherein
the sine wave and the cosine wave are dynamically generated by accumulating a fixed phase increment in the numerically controlled oscillator.

29. The method of claim 25, wherein
the complex inner product operation is configured to reduce computational complexity by using a real-based complex multiplier.
